(19) United States
(12) Patent Application Publication
(10) Pub. No.: US 2013/0073193 A1
(43) Pub. Date: Mar. 21, 2013

(54) COLLABORATIVE TRAFFIC MONITORING

(71) Applicant: Robert Luke Heavey, Cambridgeshire (GB)

(72) Inventor: Robert Luke Heavey, Cambridgeshire (GB)

(73) Assignee: CAMBRIDGE SILICON RADIO LIMITED, Cambridge (GB)

(21) Appl. No.: 13/235,677

(22) Filed: Sep. 19, 2011

(51) Int. Cl. G08G 1/00

(52) U.S. Cl. 701/119

(57) ABSTRACT

A collaborative traffic monitoring method is described. In an embodiment, a collaborative traffic monitoring system for use in a vehicle comprises an input for receiving GPS location data and a processing unit which generates speed data for a vehicle based on the received GPS location data. The system also includes a transmitter which broadcasts the speed data and a receiver which receives speed data broadcast by other vehicles. The received speed data is then used to display an indication of the road speeds ahead.

### BACKGROUND

Many systems exist to provide motorists with traffic speed information and examples include web based systems which identify traffic problems. Such web based systems may be integrated with mapping services in order to show graphically where traffic is slow. Further examples include telephone based systems where users can phone a dedicated number to receive local traffic information and satellite navigation based systems where traffic information is used in the selection of routes to a destination. These systems typically use data from a network of fixed road speed sensors, such as those which are located periodically along major routes in the UK. Many radio stations also broadcast traffic information which may also use data from this network of sensors and this data may be supplemented by information provided by listeners who phone in to report problems they experience on the roads.

With existing systems, the data received by users is typically out of date. At best, the information may only be slightly out of date (i.e. there may be a short time delay of perhaps 10 minutes in a user receiving traffic speed information); however in some instances there may be a significant delay between the occurrence (or resolution) of an incident on the road network and its reporting (e.g. a delay of 30 minutes or more). Furthermore, due to cost, planning regulations etc, the road speed sensors in the UK only cover major routes and so little or no traffic information is available for the majority of the UK road network. Similar situations exist in other countries.

The embodiments described below are not limited to implementations which solve any or all of the disadvantages of known traffic monitoring systems.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A collaborative traffic monitoring method is described. In an embodiment, a collaborative traffic monitoring system for use in a vehicle comprises an input for receiving GPS location data and a processing unit which generates speed data for a vehicle based on the received GPS location data. The system also includes a transmitter which broadcasts the speed data and a receiver which receives speed data broadcast by other vehicles. The received speed data is then used to display an indication of the road speeds ahead.

A first aspect describes a collaborative traffic monitoring system for use in a vehicle, the system comprising: an input for receiving GPS location data for the vehicle from a GPS module; a processing unit arranged to compile speed data for the vehicle using the GPS location data; a wireless transmitter arranged to broadcast the speed data; a wireless receiver arranged to receive third party speed data from other vehicles; and an output to a display device arranged to display data indicative of road speeds for a plurality of road samples ahead of the vehicle, the road speed for each road sample being computed based on the third party speed data received.

A second aspect describes a collaborative traffic monitoring method implemented in a vehicle, the method comprising: collecting speed data for the vehicle; broadcasting speed data from the vehicle using a wireless transmitter; receiving speed data broadcast by another vehicle using a wireless receiver; and displaying, on a display device, speed data for road samples ahead based on the received speed data.

A third aspect describes an in-vehicle unit for collaborative traffic monitoring, the unit comprising: a GPS module; a processing unit arranged to receive GPS location data from the GPS module and compile speed data using the GPS location data; a receiver arranged to receive speed data from other vehicles; a transmitter arranged to broadcast at least a subset of the compiled speed data and the speed data received from other vehicles; and a display arranged to display predictions of road speeds ahead, the predictions being generated based on the speed data received from other vehicles.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc and do not include propagated signals. The software can be suitable for execution on a parallel processor or a serial processor such that the method steps may be carried out in any suitable order, or simultaneously.

This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a flow diagram of a collaborative traffic monitoring method;

FIG. 2 shows schematic diagrams of two example scenarios which may be used in describing the method shown in FIG. 1;

FIG. 3 shows schematic diagrams of two example in-vehicle units;

FIG. 4 shows a further example unit 400 and a flow diagram of another example collaborative traffic monitoring method;

FIG. 5 is a flow diagram of a further example method of collaborative traffic monitoring; and

FIG. 6 shows a flow diagram of an example broadcast process and example message and data packet structures.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

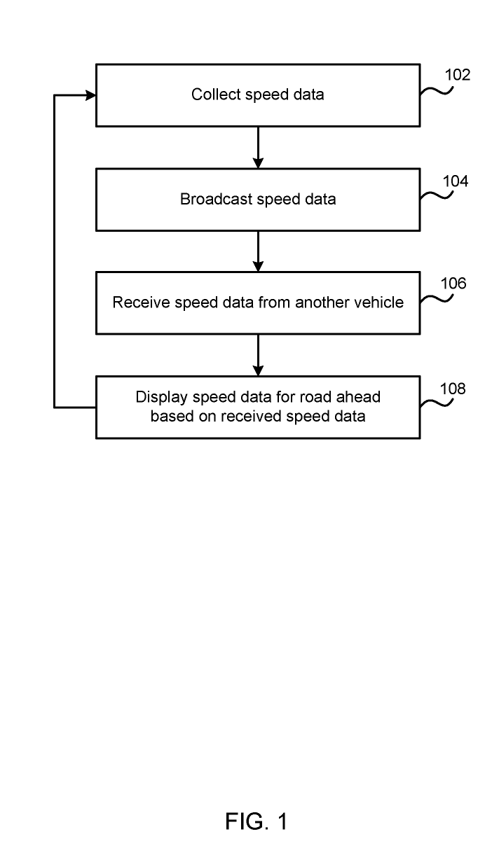

As described above, existing methods of traffic monitoring require expensive infrastructure which limits their application to less major routes and also their application in developing countries. FIG. 1 shows a flow diagram of a collaborative traffic monitoring method which does not require any infrastructure and can therefore be implemented anywhere, on any kind of road or track. The method involves vehicles collecting data about the speed they are travelling at (block 102) and broadcasting speed data (block 104). Vehicles also receive the data which is broadcast by nearby vehicles (block 106) and use the received data (i.e. the data received in block 106) to display speed data in the vehicle for the road ahead (block 108). This method is then repeated and it will be appreciated that the method steps do not need to occur in the order shown in FIG. 1 and in some examples all the method steps may be performed substantially simultaneously. The performance of one or more of the method steps need not necessarily be synchronised with the other steps in any way.

The data which is collected (in block 102) relates to the speed that the vehicle operating the method is travelling and this may be referred to as ‘experienced speed data’. This data may be in any form, including but not limited to, average speed, instantaneous speed, a combination of GPS location data (which may also be referred to as ‘GPS position data’) and timestamps, and GPS location data for two points and a time taken to travel between those two points.

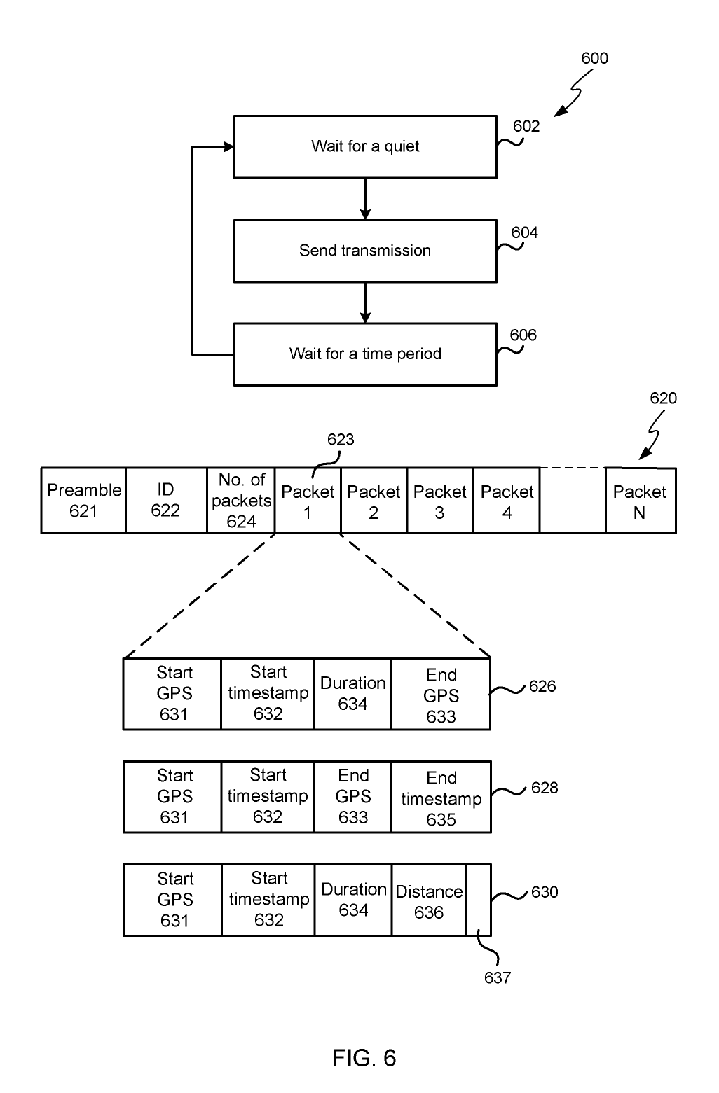

The speed data which is broadcast (in block 104) comprises a combination of experienced speed data (in block 102, the experienced speed data) and speed data which has been received from other vehicles (in block 106, where any such data is available). As described in more detail below, the speed data which is broadcast may not comprise all the speed data which is held by the broadcasting vehicle and instead the data may be filtered based on one or more criteria. In some implementations, the experienced and learned speed data may be differentiated when broadcasting the speed data (in block 104), e.g. through the use of a flag which differentiates between experienced and learned speed data (as described below with reference to FIG. 6); however, in many implementations there is no differentiation between experienced speed data and learned speed data. The broadcast speed data may also be referred to as ‘transmitted speed data’.

The speed data which a vehicle receives from other vehicles (in block 106) may be referred to as ‘received speed data’, ‘learned speed data’ or ‘third party speed data’ as this speed data does not relate to speeds experienced by the receiving vehicle. This learned speed data may comprise data received from one or more vehicles and the data received from a single vehicle may comprise data from more than one vehicle (e.g. experienced speed data collected by the broadcasting vehicle and learned speed data received by the broadcasting vehicle from other vehicles). This has the effect that a vehicle travelling in one direction down a road can receive speed data which was collected (i.e. experienced) by a vehicle ahead of that vehicle and travelling in the same direction. It is not necessary to broadcast the speed data at very high powers (to give a large transmission range) as a vehicle that is travelling in the opposite direction is used to relay the data between vehicles.

The speed data which is displayed (in block 108) relates to the road ahead of the vehicle in which the data is displayed (where this is defined with reference to the direction of travel of the vehicle). The displayed speed data provides a prediction of the road speeds (e.g. the average road speeds) ahead of the vehicle based on data received from one or more other vehicles.

The displayed speed data may be in a different format to the collected, transmitted and received speed data and in many examples the displayed speed data comprises a graphical representation of the speed data (e.g. a graphical representation of the average speed) for a number of road samples ahead of the vehicle (for the direction of travel and in some examples also for the opposite direction). Colours may be used in the graphical representation to provide an intuitive display which can easily be interpreted in a quick glance by the driver of a vehicle. As described in more detail below, the speed data which is displayed may be generated based on the received speed data and may not correspond directly to the received data and as a result this newly generated speed data which is generated for the purpose of providing a display to a driver, may be referred to as ‘interpreted speed data’. The displayed speed data is therefore indicative of road speeds for a plurality of road samples as in some examples it does not display actual speed predictions but some representation of those predicted speeds.

The term ‘speed data’ is used herein to refer to any data which describes the speed that a vehicle is travelling at (or has recently been travelling at) and may comprise any one or more of experienced speed data, learned speed data, displayed speed data, interpreted speed data etc. Furthermore, the term ‘speed data’ may refer to a collection of data relating to more than one vehicle.

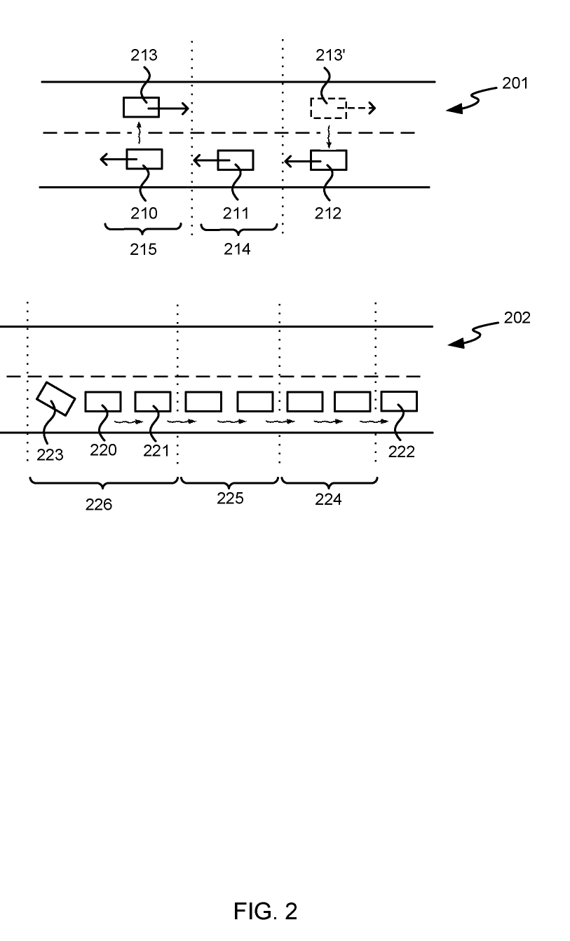

The operation of the method shown in FIG. 1 can be described in more detail with reference to the schematic diagrams shown in FIG. 2 which illustrate two example scenarios. In the first schematic diagram 201, a number of vehicles 210-213 are shown driving along a road. Three vehicles 210-212 are travelling in one direction and one vehicle 213 is travelling in the opposite direction. In this example it is assumed that at least vehicles 210, 212 and 213 are implementing the method of FIG. 1; however all the vehicles may be implementing the method. As the vehicles drive along the road, they collect speed data (block 102) and broadcast it (block 104) and they also receive speed data (block 106) from any other vehicles which are broadcasting data and which are in range. As vehicle 213 drives past vehicle 210 it receives speed data from vehicle 210 (as indicated by the wavy arrow in FIG. 1). Subsequently, when vehicle 213 has moved along the road so that it is proximate to vehicle 212 (as indicated by the dotted outline 213′), vehicle 213 broadcasts its speed data (which includes both experienced speed data and the learned speed data received from vehicle 210) and this speed data is received by vehicle 212. Based on the received speed data, speed data can be displayed in vehicle 212 for a number of road samples 214-215 ahead of the vehicle. Assuming no data was received from vehicle 211, the displayed data for the samples ahead of vehicle 212 will comprise data for the direction of travel based on the speeds experienced by vehicle 210 when driving along that section of road (and transmitted to vehicle 212 via vehicle 213) and data for the opposite direction of travel based on speeds experienced by vehicle 213. If data was received by vehicle 213 from vehicle 211, the displayed data for the sample directly ahead of vehicle 212 (sample 214) in the direction of travel may comprise a combination of the speeds experienced by both vehicles 210 and 211.

The term ‘road sample’ refers to a section of road, where the section of the road may be defined in any way and different road samples may be of different sizes and in some examples may be dynamically defined (e.g. based on current vehicle speed). In an example, a fixed grid may be used based on GPS data which divides roads into sections (e.g. using a 0.5 km grid). In other examples the road sample size which is used may be different based on the road type and this is described in more detail below. Depending on the nature of the speed data broadcast by vehicles it is not necessary for each vehicle to have the same definition of road sample and road sample boundaries need not be aligned in any way, e.g. where the speed data comprises GPS location data and timestamps or duration information, a vehicle can process the data to compute the average road speed for any arbitrary section of the road. This is also described in more detail below.

The second schematic diagram 202 in FIG. 2 can be used to describe the operation of the collaborative traffic monitoring method of FIG. 1 in a different situation: in slow moving or stationary traffic. In the example shown, there is a queue of very slow moving or stationary vehicles (including vehicles 220-222) on one side of the road as a result of an accident (involving vehicle 223, where the direction of travel of vehicles 220-223 is right to left in the example shown in diagram 202) and there are no vehicles travelling in the opposite direction. This means that there is no vehicle travelling in this opposite direction (left to right in the example shown in diagram 202) which can act as a relay for data broadcast by vehicles in the queue. In this instance, however, the vehicles are sufficiently close to each other that a vehicle in the queue can receive speed data broadcast by at least the vehicle in front (and potentially more than one vehicle in front). As described above, if a vehicle in the queue (vehicle 221) receives speed data broadcast by a vehicle ahead of that vehicle (e.g. data broadcast by vehicle 220 or 223), this received speed data will then be incorporated into the speed data which is broadcast by that vehicle (i.e. by vehicle 221). This method is repeated by any vehicles in the queue which are arranged to implement collaborative traffic monitoring and so the speed data ripples back through the queue (as indicated by the wavy lines in the diagram) and is subsequently received by vehicle 222 at the end of the queue of traffic.

Based on the received speed data (and as described above), speed data can be displayed in vehicle 222 for a number of road samples 224-226 ahead of the vehicle. In the direction of travel, all the samples 224-226 will show stationary (or very slow moving) traffic in the direction of travel and for all the samples there will be no data for the opposite direction of travel. There may be no data available for the sample ahead of the accident (e.g. because this part of the road is clear of traffic) and this provides the driver of vehicle 222 with an indication of the length of the queue. When the incident is subsequently cleared and vehicle 220 is able to move, the updated speed data will be received by vehicle 222 through the transfer of data along the vehicles in the queue and so the driver of vehicle 222 will receive an early indication that the problems ahead have been resolved. This indication will be received by the driver of vehicle 222 virtually in real time and far faster than any updates could possibly be received using conventional methods.

It will be appreciated that further example scenarios may use a combination of the data transmission techniques shown in FIG. 2, i.e. there may be some vehicle-vehicle transfer of data via a vehicle travelling in the opposite direction (as in diagram 201) and there may be some vehicle-vehicle transfer of data between vehicles which are travelling in the same direction (as in diagram 202).

The discussion above in relation to FIG. 2 describes data being received by a vehicle from a vehicle ahead of it in the queue or vehicle-vehicle transfer of data. It will be appreciated that the broadcast of the speed data (in block 104) is a not a one-to-one connection (vehicles do not transmit data to a specific vehicle, e.g. data is not transmitted from vehicle 220 to vehicle 221) but instead is a blind, unsolicited broadcast from a vehicle to any vehicles which are suitably equipped, within range and are listening (e.g. vehicle 220 broadcasts the data and the data is received by vehicle 221 as it is in range of the broadcast from vehicle 220). The broadcast may be non-directional (or omni-directional) such that the data may be received by vehicles all around the broadcasting vehicle, e.g. vehicles ahead, behind and to the side of that vehicle (e.g. in a multi-lane road such as a motorway). Data is broadcast by a vehicle even when there is no vehicle within range and as such the broadcast may be described as opportunistic.

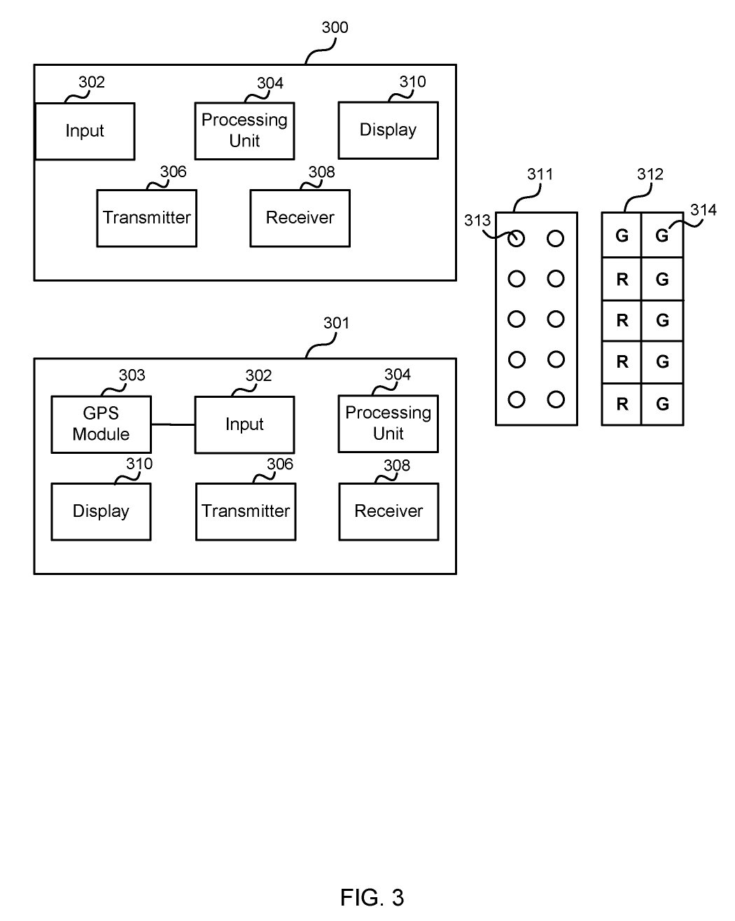

The collaborative traffic monitoring method described above may be implemented in an in-vehicle unit and FIG. 3 shows schematic diagrams of two example in-vehicle units 300, 301. The term ‘in-vehicle unit’ is used to refer to any unit or module which may be used within a vehicle. An in-vehicle unit may be a stand-alone piece of equipment which may be fixed in the vehicle or removable from the vehicle, or alternatively the functionality of the in-vehicle unit may be integrated within other in-vehicle equipment. For example, the functionality may be integrated within a vehicle audio system (e.g. radio) or a satellite navigation unit. In a further example, the functionality may be integrated within the vehicle's interior, dashboard electronics (e.g. within the instrument cluster) or engine/vehicle management system.

The first example unit 300 comprises an input 302 for receiving GPS location data from a GPS module, which in this example is external to the unit. In the second example unit 301, the GPS module 303 is internal to the unit. Each unit 300, 301 also comprises a processing unit 304 which is arranged to compile (or collect) speed data for the vehicle (the experienced speed data) using data from the GPS module (whether internal or external to the unit). The speed data is broadcast using a wireless transmitter 306 and speed data is received from other vehicles using a wireless receiver 308. Each unit 300, 301 further comprises a display module 310 arranged to display a representation of the road speeds for samples of road ahead of the vehicle in which the unit is located.

The processing unit 304 may comprise one or more processors which may be microprocessors, controllers or any other suitable type of processors for processing computer executable instructions to compile speed data and in some examples also to generate an output to the display module and/or to process speed data to generate interpreted speed data. In some examples, for example where a system on a chip architecture is used, the processors may include one or more fixed function blocks (also referred to as accelerators) which implement a part of the method of compiling speed data, generating interpreted speed data and/or generating an output to the display module in hardware (rather than software or firmware). The computer executable instructions may be provided using any computer-readable media that is accessible by the processing unit 304.

In an example the processing unit 304 may comprise computer-readable media arranged to store the computer executable instructions which are executed by the unit, or alternatively such instructions may be stored externally to the processing unit 304 and accessed by the processing unit.

Computer-readable media may include, for example, computer storage media such as memory and communications media. Computer storage media, such as memory, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se.

Any suitable display method may be used to display a representation of the road speeds for samples of road ahead of the vehicle in which the unit is located and two example displays 311, 312 are shown in FIG. 3. In the first example display 311, LEDs 313 (e.g. tricolour LEDs or a set of different colour LEDs) are used to provide an indication of road speed in each road sample, with two LEDs being provided for each road sample (one for each direction of travel). In the second example display 312, similar information is displayed using coloured squares (or cells) 314 on an LCD display. In this example, the letters R and G are used in the diagram to indicate squares which would be coloured red or green, where red squares indicate very low speeds and green squares indicate higher speeds (e.g. >25 mph). In another example, the LEDs/cells may be used as follows to provide speed information to the driver or another occupant of the vehicle:

| Display | Description |
|---|---|
| Unlit | There is no data for this road sample. |
| Red | Average road speed for the sample is less than 10 mph. |
| Amber | Average road speed for the sample is 10 mph or greater, but less |
| | than 25 mph. |
| Green | Average road speed for the sample is greater than 25 mph. |

In further examples, any combination of colours for different speed ranges may be used.

The examples shown in FIG. 3 show data for both directions of travel; however, in examples where a display only shows data for the direction of travel (and not the opposite direction), it will be appreciated that only one LED/cell per road sample may be required.

In some example implementations of an in-vehicle unit, the input 302, processing unit 304, transmitter 306 and receiver 308 may be implemented on a single silicon chip which may be considered a partner chip which operates alongside a GPS chip (which may be considered to be a GPS module). In a further example implementation, the GPS module 303, input 302, processing unit 304, transmitter 306 and receiver 308 may be implemented in a single silicon chip.

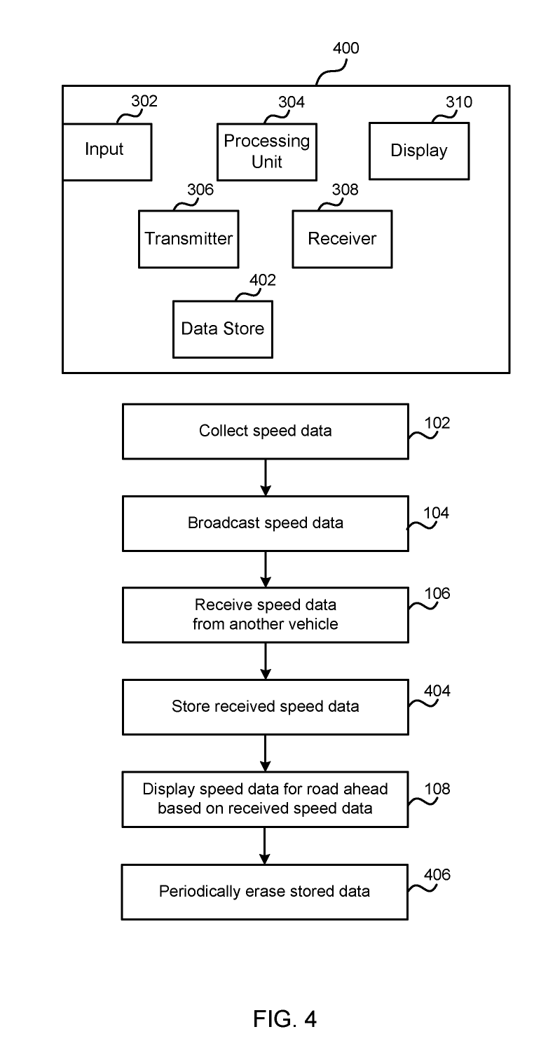

FIG. 4 shows a further example unit 400 and a flow diagram of another example collaborative traffic monitoring method (which is a modified version of the method shown in FIG. 1 and described above). It can be seen that the example unit 400 in FIG. 4 also comprises a data store 402. This data store 402 is used to store the received speed data (block 404). In order that the stored speed data does not become out of date, which may result in displaying out of date information (in block 108), the stored data is periodically erased (block 406). In an example all the stored data may be erased (in block 406) when the vehicle's engine is stopped (and/or started). In another example, which may be more appropriate for vehicles on long journeys or commercial vehicles which have their engines running for long periods of time, elements of the stored data may be erased (in block 406) based on a timestamp associated with the data, e.g. data (e.g. an element of data) may be deleted when it is one hour old. The erasing of data (in block 406) may be implemented by the data store 402 itself, the processing unit 304, or by another module within or external to the unit 400.

The stored data may be the raw data which is received or a processed form of the data (e.g. as described in more detail below). In some examples, the stored data may comprise aggregate data for road samples; however, where aggregated data is stored, it may only be possible to erase the data on start up/switch off, instead of periodically based on the timestamp associated with any element of the data received.

In an example of one of the in-vehicle units 300, 301, 400 in operation, when the vehicle which carries the unit is switched on, all of the cells (or squares or LEDs) in the display are switched off (or in another defined state which indicates that there is no data) because no transmissions have been received and so nothing is known about the road conditions ahead. The unit does not transmit any speed data until a road sample has been travelled (and so some experienced speed data has been collected) or some learned speeds are received from another in-vehicle unit. When a transmission is received from another unit, the road speed information is received and saved as the latest known. The display can then be updated with speed data (which may be interpreted speed data). The unit is now active and roaming and gathering (experienced) speed data. The unit starts transmitting its known speed for past travelled roads and learned speed data received from other units. In an example implementation, the unit robustly broadcasts its speed information until it is switched off (irrespective of whether there is any nearby traffic to receive the broadcast messages). As other broadcast messages are received, the learned information is saved and the display updated.

The in-vehicle units 300, 301, 400 shown in FIGS. 3 and 4 all comprise a display module 310; however, in further examples an in-vehicle unit may not comprise a display module but instead may comprise an output to an external display, such as an instrument cluster display, car stereo display, satellite navigation system display, etc.

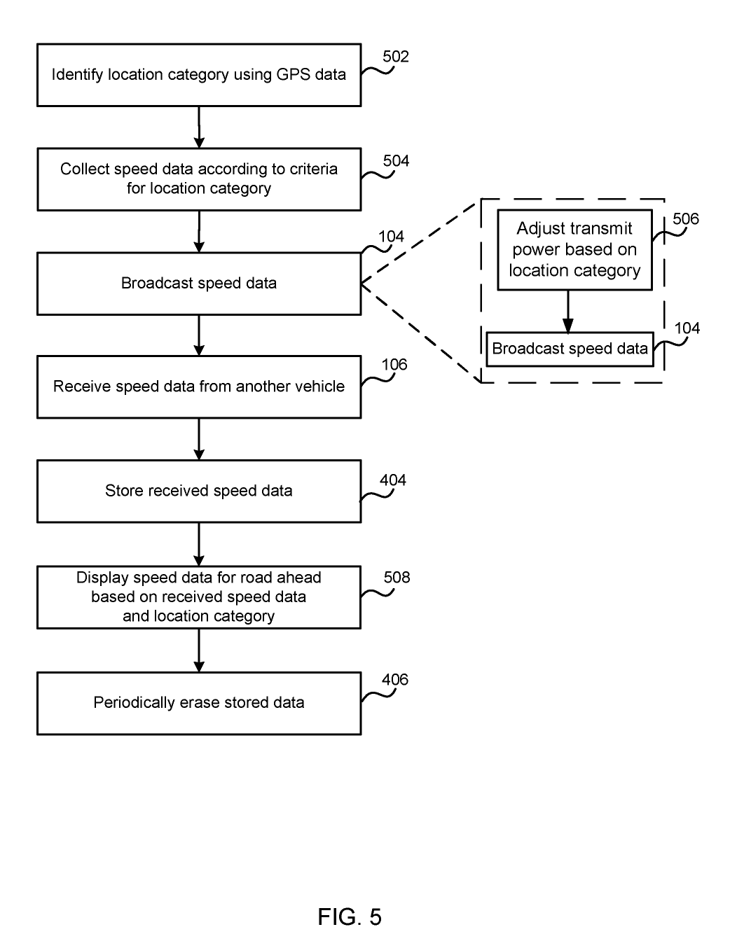

FIG. 5 shows a flow diagram of a further example method of collaborative traffic monitoring which may be considered a modified version of either of the methods previously described (and shown in FIGS. 1 and 4). This method uses the concept of a ‘location category’ (identified in block 502) which determines the way in which speed data is collected (in block 504) and displayed (in block 508). The location category may in addition (or instead) be used to adjust transmission parameters, such as transmission power (in block 506), which are used when broadcasting the speed data (in block 104).

The identification of a location category (in block 502) may, for example, be implemented in a processing unit 304 within an in-vehicle unit or a separate module may be provided within a unit. Where transmitter power (or other transmit parameters) are adjusted based on location category (e.g. in block 506), this may be done by the processing unit 304, transmitter 306 or another module within or external to the unit.

The term ‘location category’ is used herein to refer to a classification of the current location of a vehicle and these categories may be defined in any way. Criteria may be associated with a location category that define that category and/or that define the way in which aspects of the collaborative traffic monitoring method are changed as a result of the current location being classified as a particular location category. Examples of location categories which may be used include, but are not limited to, rural, urban, city and motorway and an example system may use two or more location categories (e.g. a location may be classified as either rural and not-rural). The location may be classified (and a category selected from the categories used by the system) based on one or more of: GPS location data (i.e. actual GPS position), GPS mapping data (e.g. which specifies which road the vehicle is travelling on) and vehicle speed (in block 502). Where GPS location data is used, a database may be provided within the unit which maps GPS position data to a particular category. In an example, the database may define regions which are categorised as “urban” and positions outside the defined regions may be categorised as “rural”. Where GPS mapping data is used, a location may be categorised as “urban” if it is within a town boundary, “city” if it is within a city boundary (and which may be considered a subset of “urban” in some implementations), and “motorway” if it is on a motorway (e.g. if the vehicle is travelling along the M25 in the UK). Where speed is used, a location may be categorised as “urban” if the vehicle is travelling at 40 mph or less and a location may otherwise be categorised as “non-urban” or “rural”. Other naming conventions for categories may alternatively be used (e.g. “fast road”, “slow road”). It will be appreciated that where speed is used, this may be determined based on GPS location data or based on speedometer (or other vehicle instrument) readings.

As shown in FIG. 5, there are many ways that use of a location category may affect the implementation of the collaborative traffic monitoring method and in any implementation, the location category may be used in none, some or all of the ways shown. In a first example, the location category may be used to select the road sample size which has an effect on the way that speed data is displayed (in block 508) and in some implementations may also have an effect on the way that the speed data is collected (in block 504), e.g. where data is collected on a scale based on the road sample length. For motorways and rural locations, a longer sample length may be used than in urban and city locations. In an example, a sample length of 1000 metres may be used for motorways and rural locations, a length of 500 m for urban locations and in a city location, a sample length of 50 m or 100 m may be used.

The design of the sample length may be optimized for low speed operation because the collaborative traffic monitoring system is most useful when there are traffic problems which result in vehicles moving slowly. If the system is not optimized for situations where the traffic is free flowing and/or sparse, this does not matter as there will be little to inform the driver about even if the system was optimized for such a scenario.

As also shown in FIG. 5, the transmit power (or other transmit parameters) which are used in broadcasting speed data (in block 104) may be adjusted (in block 506) based on the location category. In an example, where the location is categorised as a city, the transmit power may be reduced, e.g. to give a broadcast range of approximately 25 m from the vehicle. Such a range may encompass about 10 vehicles in slow moving or stationary traffic (as in the scenario shown in the second diagram 202 in FIG. 2) and by reducing the power, the level of interference will be reduced and the amount of duplicative data that a vehicle receives (because each vehicle rebroadcasts the speed data it receives) is reduced. In another example, the frequency used for transmission may be changed according to location category (e.g. to a higher frequency for city/urban locations so that transmissions are limited to line of sight with minimal bleeding around corners).

In a variation of the method shown in FIG. 5, the speed data collection, display of speed data and/or transmit parameters may instead be varied according to alternative criteria instead of (or in addition to) location category. In an example, vehicle speed may be used to define road sample size, with one road sample size (e.g. 2000 m) used in vehicles which are travelling at 30 miles per hour (mph) and above and another, smaller, road sample size (e.g. 500 m) used in vehicles that are travelling at less than 30 mph. The transmit power may also be reduced for vehicles travelling below 30 mph. It will be appreciated that 30 mph is provided as an example speed threshold and an alternative value may be used or there may be more than one threshold (e.g. 30 mph and 60 mph) with step changes in road sample length when a threshold is crossed (e.g. with a first sample length <30 mph, a second, larger, sample length for speeds of 30 mph or more but less than 60 mph, and a third, even larger, sample length for speeds of 60 mph or more).

In another variation of the method shown in FIG. 5, receive parameters may be varied according to location category and/or alternative criteria. Examples of receive parameters include, but are not limited to, frequency and amplifier gain and any changes to receive parameters may correspond to changes made to transmit parameters for a particular location category (e.g. so that for any location category, the transmit and receive frequencies are the same) or the changes to receive parameters may be independent of any changes made to transmit parameters.

Where a vehicle operates using the method of FIG. 5 and with location category (and hence road sample length and/or transmit parameters) being set based on GPS data (either position or mapping data), in situations where GPS lock has not been achieved or where it has been lost (e.g. in a tunnel), the method may resort to using a speed based method (as described above) or may default to a standard set of values or a default location category (e.g. rural) and then use measurements of linear distance (e.g. from the vehicle speedometer) to collect speed data for the vehicle until GPS data is available again.

As described above, different vehicles may use different methods to calculate road sample length and hence define how regularly speed data is collected. It is not necessary for all vehicles to use the same method or have the same definition of a road sample. Instead, the received speed data is processed in a vehicle according to that vehicle's current definition of a road sample in order to generate the speed data for display (e.g. in block 108 or 508).

In an example method of processing the received speed data, the speed data received by a vehicle is in the format (position 1, position 2, time taken to travel between position 1 and position 2) and a vehicle receives the following data:
(1, 3, 4)
(3, 5, 3)
(5, 7, 1)

If the vehicle has a road sample length of 1 unit (rather than the 2 units of the vehicle that generated the received speed data), then the processing unit will generate the following speed data:
Sample 1 (position 1 to position 2), speed=2
Sample 2 (position 2 to position 3), speed=2
. . .
Sample 4 (position 4 to position 5), speed=1.5
Sample 5 (position 5 to position 6), speed=0.5
. . .

Or, for different sample boundaries:
Sample 1′ (position 1.5 to position 2.5), speed=2
Sample 2′ (position 2.5 to position 3.5), speed=1.75 (average of 2 and 1.5)
. . .

As described above, the speed data which is generated by the processing unit in order to be able to display data to the driver of the vehicle may be referred to as interpreted speed data. Furthermore, although the processing is described as being performed by the processing unit 304, in other implementations, the processing may alternatively be performed by the display unit 310 itself or by another module within an in-vehicle unit.

In examples where the speed data which is collected comprises an average speed over a road sample (and not GPS positions and some associated time data, e.g. timestamps and/or duration data) there may be some situations where the road speeds may be so slow that computing an average speed over a short, city-based, road sample length of 50-100 m is not practical. In such examples, the method may change the speed data collected from an average speed over a road sample to another value, such as the time taken to travel 100 m. Furthermore, in such examples where the speed data comprises an average speed over a road sample and where a vehicle does not travel a full sample distance for the geographic region that it is in (e.g. city/urban/rural/motorway), the average speed over the portion of the sample travelled may be collected and broadcast instead.

The broadcast of speed data (in block 104) may use any suitable radio frequency (e.g. hundreds of MHz) and protocol and any suitable message format (e.g. messages transmitted in the form of short bursts which may, for example, be no longer than 0.25 seconds). In particular, radio frequencies in licence free bands may be used and in some implementations, the radio transmissions may be adopted as an additional broadcast message type by existing protocols such as Bluetooth®, WiFi and ZigBee®. In an example implementation of the broadcast process (block 104), as shown in the flow diagram 600 in FIG. 6, a unit waits for a quiet, i.e. for a slot (or other time interval) in which no radio transmission is being received, (block 602) and then sends its transmission (block 604). The unit then waits a defined (or fixed) time period (block 606) before starting the method again (i.e. by waiting for a quiet). Alternatively, the unit may wait for a random time period (in block 606) before starting the method again.

FIG. 6 also shows an example structure of a message 620, where each broadcast by a unit (in block 104) may comprise one or more of such messages. The message 620 starts with a preamble 621, followed by an optional message ID 622. The message also comprises one or more packets 623 of speed data and where the method allows a variable number of packets N to be included within a message, the message may further comprise a field 624 which indicates the number of packets included within the message. In an example, the number of packets may be limited, for example, to 16 packets (i.e. N≦16) where these 16 packets comprise 8 packets for each direction of travel. Where a unit has more speed data than can be included within a single packet, the data may be truncated and split across more than one message or the most recent speed data may be selected and included within a single message (which assists in ensuring that the data received by any unit is not out-of-date).

As described above, the speed data which is collected by a unit may have different forms and FIG. 6 also shows three examples 626-630 of data packets 623 which may be included within the message 620. Each of the examples shown includes a start GPS position 631 and a start timestamp 632 (i.e. a timestamp which corresponds to the time that the vehicle/unit was at the start GPS position). The first example 626 then also comprises an end GPS position 633 and a duration 634 which is the time taken to travel between the start GPS position and the end GPS position. The second example 628 includes the end GPS position 633, but instead of a duration includes an end timestamp 635 (i.e. a timestamp which corresponds to the time that the vehicle/unit was at the end GPS position). The third example 630 includes a duration 634 (like the first example) and a distance travelled in that duration 636. The third example 630 also comprises a flag field 637 which may be used to indicate whether the packet comprises experienced speed data or learned speed data and such a flag field may also be included within the other examples 626, 628.

It will be appreciated that the example data packets shown in FIG. 6 provide just some examples of combinations of the various fields which may be included within the speed data. Depending upon the implementation, flag fields 637 may be used or there may be no differentiation between learned and experienced speed data.

In the collaborative traffic monitoring system described above, the system comprises a plurality of vehicles operating the method (through use of in-vehicle units) and each vehicle operates autonomously. Each vehicle broadcasts speed data opportunistically and any speed data which is received is used to update the data which is displayed to the driver (or other occupants) of the vehicle. In some examples, the system may further comprise in-vehicle units which act as receivers only and do not collect or broadcast speed data. Such units, which may be legacy equipment which is capable of interpreting the message format, may comprise a subset of the elements of the units shown in FIGS. 3 and 4 (e.g. processing unit 304, receiver 308 and display module 310 and possibly data store 402) and therefore only perform a subset of the steps shown in FIGS. 1, 4 and 5 (e.g. block 106 and block 108 or 508, plus optionally one or more of blocks 404 and 406). In some further examples, the system may additionally comprise one or more stationary sensors which are arranged to receive the broadcast speed data and re-broadcast the data across a broader geographic area and/or to feed the data into other traffic monitoring systems, for example, to augment an existing traffic monitoring system which uses road-side infrastructure.

The methods described above use a collaborative process with speed data being shared between vehicles in order to provide substantially real-time data to drivers and other vehicle occupants over any part of a road network. This information on road speeds (or road speed predictions) may enable a driver to take decisions to drive smarter by reducing speed and possibly diverting before a blockage. No infrastructure investment is required and road distances and/or transmission parameters (e.g. transmit power) may be adjusted to suit town and country travel distances (or any other classification of the road network).

As described above, the methods described herein are applicable to any kind of road, track, path etc which is travelled by vehicles. Any use of the term ‘road’ in the above description is by way of example only.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A collaborative traffic monitoring system for use in a vehicle, the system comprising:
an input for receiving GPS location data for the vehicle from a GPS module;
a processing unit arranged to compile speed data for the vehicle using the GPS location data;
a wireless transmitter arranged to broadcast the speed data;
a wireless receiver arranged to receive third party speed data from other vehicles; and
an output to a display device arranged to display data indicative of road speeds for a plurality of road samples ahead of the vehicle, the road speed for each road sample being computed based on the third party speed data received.

2. A collaborative traffic monitoring system according to claim 1, wherein the wireless transmitter is arranged to broadcast both speed data compiled by the processing unit and third party speed data received from other vehicles.

3. A collaborative traffic monitoring system according to claim 2, wherein the speed data broadcast by the wireless transmitter comprises a plurality of messages, each message comprising at least one data packet, the data packet comprising at least one GPS position and at least one timestamp.

4. A collaborative traffic monitoring system according to claim 1, wherein the processing unit is arranged to process the third party speed data to compute the road speeds for each of the plurality of road samples ahead of the vehicle, the computed road speeds comprising predictions of road speeds for each of the plurality of road samples ahead of the vehicle.

5. A collaborative traffic monitoring system according to claim 1, wherein the data indicative of road speeds for a plurality of road samples ahead of the vehicle comprises a graphical representation of road speed for each of the plurality of road samples.

6. A collaborative traffic monitoring system according to claim 1, further comprising:
a data store arranged to store the third party speed data.

7. A collaborative traffic monitoring system according to claim 6, wherein one of the data store and the processing unit is arranged to periodically erase elements of the stored third party speed data.

8. A collaborative traffic monitoring system according to claim 1, wherein the processing unit is further arranged to:
determine a location category using the GPS location data; and
compile speed data for the vehicle using the GPS location data according to criteria specified for the determined location category.

9. A collaborative traffic monitoring system according to claim 8, wherein the processing unit is further arranged to:
adjust a transmission parameter used by the wireless transmitter to broadcast the speed data, wherein the transmission parameter is adjusted based on the determined location category.

10. A collaborative traffic monitoring system according to claim 8, wherein the criteria specified for the determined location category comprises a road sample length for the determined location category.

11. A collaborative traffic monitoring system according to claim 1, wherein the wireless transmitter is arranged to wait for time interval in which no radio transmission is received before broadcasting the speed data and to wait for a time period following broadcast of the speed data before repeating this process.

12. A collaborative traffic monitoring system according to claim 1, further comprising the display device.

13. A collaborative traffic monitoring system according to claim 1, further comprising the GPS module.

14. A collaborative traffic monitoring system according to claim 1, wherein at least the input, processing unit, wireless transmitter and wireless receiver are integrated on a single silicon chip.

15. A collaborative traffic monitoring system according to claim 1, wherein at least the input, processing unit, wireless transmitter and wireless receiver are integrated within one of a vehicle audio system and a vehicle management system.

16. A collaborative traffic monitoring method implemented in a vehicle, the method comprising:
collecting speed data for the vehicle;
broadcasting speed data from the vehicle using a wireless transmitter;
receiving speed data broadcast by another vehicle using a wireless receiver; and
displaying, on a display device, speed data for road samples ahead based on the received speed data.

17. A collaborative traffic monitoring method according to claim 16, further comprising:
storing the received speed data in a data store; and
periodically erasing elements of the stored speed data.

18. A collaborative traffic monitoring method according to claim 16, further comprising:
identifying a location category using GPS data; and
changing an aspect of at least one of the collection, broadcast and display of speed data based on criteria associated with the identified location category.

19. An in-vehicle unit for collaborative traffic monitoring, the unit comprising:
a GPS module;
a processing unit arranged to receive GPS location data from the GPS module and compile speed data using the GPS location data;
a receiver arranged to receive speed data from other vehicles;
a transmitter arranged to broadcast at least a subset of the compiled speed data and the speed data received from other vehicles; and
a display arranged to display predictions of road speeds ahead, the predictions being generated based on the speed data received from other vehicles.

20. An in-vehicle unit according to claim 19, wherein the predictions of road speeds ahead comprise a prediction of road speed for each of a plurality of road samples ahead, each road sample having a length defined based on GPS location data.
